(19) United States
(12) Patent Application Publication
(10) Pub. No.: US 2003/0014549 A1
(43) Pub. Date: Jan. 16, 2003

(54) Communication component manager and associated components

(75) Inventors: Glenn R. Seidman, Woodside, CA (US); Hetal R. Velani, Mountain View, CA (US)

Correspondence Address: MICHAEL B. EINSCHLAG, ESQ., 25680 FERNHILL DRIVE, LOS ALTOS HILLS, CA, 94024, US

(73) Assignee: Verano

(21) Appl. No.: 09/877,328

(22) Filed: Jun. 8, 2001

(51) Int. Cl. G06F 15/163; G06F 9/00; G06F 9/54

(52) U.S. Cl. 709/310

(57) ABSTRACT

One embodiment of the present invention is a component manager that manages one or more communication components that implement one or more communication protocols, the component manager including: (a) an encapsulator that generates an object implementation of a pre-established interface for each of the one or communication components, wherein each such object implementation of the interface provides indirect access to its associated communication component and directives to the component manager that must be executed on behalf of the associated communication component, which directives are not communicated to the associated communication component; (b) a directory service object submitter that inserts an object representing a client interface for a communication component into a directory, which object can be retrieved using a name assigned to the communication component; (c) a synchronous transmitter invoker that executes an identified synchronous transmit method in a communication component that implements a transmitter interface to synchronously transmit a payload; and (d) a synchronous receiver invoker that executes an identified synchronous receive method in a communication component that implements a receiver interface to synchronously receive a payload.

### TECHNICAL FIELD OF THE INVENTION

The present invention pertains to component managers, components associated with the component managers, and methods and apparatus for fabricating the component managers and their associated components. In particular, the present invention pertains to a communication component manager (for example, a communication component manager embodied as an Enterprise CommunicatorBean container) and communication components (for example, communication components embodied as Enterprise CommunicatorBeans) associated therewith.

### BACKGROUND OF THE INVENTION

Communications infrastructure is an essential part of every enterprise computing environment, particularly those that interact with systems over a network such as, for example, the Internet. At present, it has become increasingly important for such systems to be able to communicate using multiple communication protocols.

When constructing communication infrastructures that support multiple communication protocols, a typical prior art approach is to generate and implement code that addresses each protocol as it becomes required to use each protocol. Problems arise in such an approach because, typically: (a) code for implementing a particular protocol is not shared in implementing other protocols; and (b) generating code for each implementation can be difficult. The difficulties arise because an implementation of a communication protocol often needs to be separated into a receiver and transmitter implementation. Additionally, secure versions of such an implementation of a communication protocol typically result in constructing separate secure receiver and secure transmitter implementations. As a result, it has become cumbersome to introduce implementations of new communication protocols. Further difficulty arises in that it is not always clear how to integrate such implementations of new communications protocols.

HP Bluestone has constructed a Unified Listener Framework (ULF) which enforces an organized structure for use in implementing, and provides an ability to introduce new communication protocols. However, in order to do so, protocol implementers are required to be aware of, and to code, processing involving features such as thread pooling and retries. Further, implementing secure communication protocols involves totally new and separate implementations.

In light of the above, there is a need for methods and apparatus that enable implementers of communication protocols to overcome the above-identified problems in the prior art.

### SUMMARY OF THE INVENTION

Embodiments of the present invention advantageously satisfy the above-identified need in the art. In particular, one embodiment of the present invention represents a communication component manager (embodied, for example, as a container) that provides freely gained characteristics for communication by associating components with the communication component manager (for example, by dropping the components into the container)—along with simple text declarations, representing communication component manager instructions for each component (for example, set forth in a deployment descriptor). Advantageously, a communication component manager fabricated in accordance with this embodiment provides a simple, unified framework for communication protocol implementations such that a developer need only focus on the transmission or reception of an opaque payload. In accordance with another embodiment of the present invention, functionality and/or features such as, for example, thread pooling, retries, polling, and an encryption algorithm may be declared in a deployment descriptor.

Specifically, one embodiment of the present invention is a component manager that manages one or more communication components that implement one or more communication protocols, the component manager comprising: (a) an encapsulator that generates an object implementation of a pre-established interface for each of the one or communication components, wherein each such object implementation of the interface provides indirect access to its associated communication component and directives to the component manager that must be executed on behalf of the associated communication component, which directives are not communicated to the associated communication component; (b) a directory service object submitter that inserts an object representing a client interface for a communication component into a directory, which object can be retrieved using a name assigned to the communication component; (c) a synchronous transmitter invoker that executes an identified synchronous transmit method in a communication component that implements a transmitter interface to synchronously transmit a payload; and (d) a synchronous receiver invoker that executes an identified synchronous receive method in a communication component that implements a receiver interface to synchronously receive a payload.

### BRIEF DESCRIPTION OF THE FIGURE

FIG. 1 shows symbols used in the Detailed Description to describe various software entities and their interrelationships;

FIG. 2 shows various of the interrelationships shown in FIG. 1;

FIG. 3 shows a Transmitter interface, a MultiTransmitter interface, and a Receiver interface that are fabricated in accordance with the present invention;

FIG. 4 shows how a container fabricated in accordance with the present invention provides an object that implements a CommunicatorContext interface to a deployed communication component;

FIG. 5 shows a component deployment file;

FIG. 6 shows a block diagram of components of FIG. 5 that are deployed in an ECOMB Container with a thread multiplicity that was designated in a Deployment Descriptor;

FIG. 7 shows a block diagram of software subsystems (along with their interrelationships) that comprise one embodiment of the present invention;

FIG. 8 shows a block diagram of an XML grammar structure of an ECOMB JAR that is fabricated in accordance with the present invention;

FIG. 9 shows a block diagram of an XML grammar structure of receiver beans that is fabricated in accordance with the present invention;

FIG. 10 shows a block diagram of an XML grammar structure of transmitter or multicast-transmitter beans that is fabricated in accordance with the present invention; and

FIG. 11 shows a block diagram of an XML grammar structure of cryptographer beans that are fabricated in accordance with the present invention.

### DETAILED DESCRIPTION

In accordance with one embodiment of the present invention, a communication component manager enables software components developed according to a new design pattern to be deployed, and to enjoy advantages for communicating remotely on behalf of local software systems, without having to code explicitly to obtain such advantages. In accordance with one or more embodiments of the present invention, scalable, guaranteed, secure, audited, remotely controlled, transport of payloads are realized by utilizing optional declarations in a deployment descriptor.

In accordance with one embodiment of the present invention: (a) an inventive communication component manager is an Enterprise CommunicatorBean Container or “ECOMB Container” whose purpose is primarily, but not exclusively, to provide partner-to-partner communication; and (b) an inventive communication component is an Enterprise CommunicatorBean. In accordance with this embodiment, the ECOMB Container is a secure communications manager that provides low-level communication and transport of payloads between computer subsystems and is designed to enable one or more of the following: (a) delivery of opaque payloads (i.e., implementations of communication protocols are not aware of content within payloads they transport, and, as a result, implementations of communication protocols are responsible only to transmit and receive the requested payloads); (b) communication with partners without requiring partners to employ specific software; (c) support for as many standard communication protocols as possible; (d) support for multicast transmission; (e) support for secure protocols; (f) guaranteed delivery; and (g) a unified interface across all communication protocols. In one embodiment of the present invention, functionality such as: (a) scheduled (for example, intentionally delayed) transmissions; and (b) transactional payload migration are performed at a higher level than that of the Secure Communications Manager.

Advantageously, in accordance with this embodiment, an ECOMB Container unburdens Enterprise CommunicatorBean developers from having to code several aspects of high performance communication. Instead, by conforming to Enterprise CommunicatorBean interfaces, and designating parameters in an ECOMB Deployment Descriptor, the ECOMB Container will perform specialized processing on behalf of an Enterprise CommunicatorBean. For example, in accordance with one embodiment of the present invention, an ECOMB Container handles one or more aspects of the following processing functionality: (a) thread pooling (as will be described in detail below, in accordance with one embodiment of the present invention, CommunicatorBeans declare a pool size in a deployment descriptor); (b) poll scheduling (as will be described in detail below, in accordance with one embodiment of the present invention, a ReceiverBean -a specific type of Enterprise CommunicatorBean—developer need only code how to receive payload in a single method, because the ECOMB Container performs a polling schedule); (c) routing of a received communication payload (as will be described in detail below, in accordance with one embodiment of the present invention, listeners get notified with a received payload regardless of which specific thread in a pool actually receives a communication); (d) encrypting (as will be described in detail below, in accordance with one embodiment of the present invention, an encryption service is invoked by Enterprise CommunicatorBeans declaring that payload be encrypted in a deployment descriptor); and (e) guaranteed delivery for synchronous protocols (as will be described in detail below, in accordance with one embodiment of the present invention, the ECOMB Container will automatically retry transmissions on failure).

In accordance with one embodiment of the present invention, an ECOMB Container operates on a network server wherein clients (i.e., client software subsystems) requiring communications reside in the same server. Further embodiments of the present invention cover situations where clients reside in a distinct server. Note that whenever clients reside in the same network server as an ECOMB Container of the present invention, the clients may access the ECOMB Container in their same process or in a distinct process.

An ECOMB Container fabricated in accordance with the present invention provides a component manager in the form of a container architecture wherein components may be deployed into the container to gain beneficial dynamics and services. In accordance with one embodiment of the present invention, contracts (for example: a container/component contract; a client/component contract; and a deployment contract) are specified by way of interfaces (the interfaces include an administrative user interface) and a deployment model.

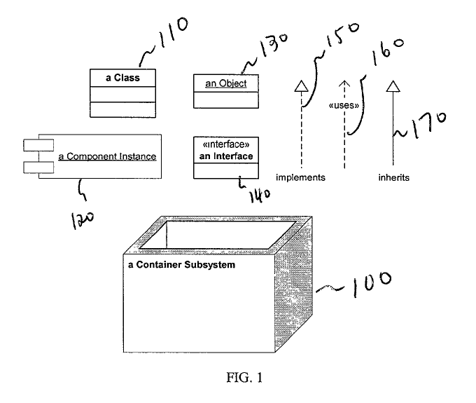

The following detailed description of embodiments of the present invention employs UML structure diagrams that are well known to those of ordinary skill in the art to describe various software entities and their relationships. Note, however, that the container subsystem symbol shown, for example, in FIG. 1, is not an UML standard, but it is used to better illustrate that some embodiments of the present invention comprise a container that “contains” components that get deployed thereinto.

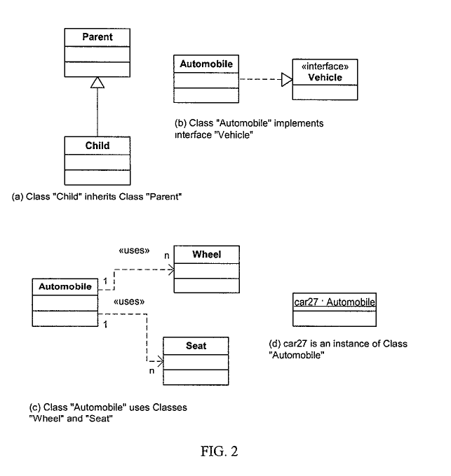

FIG. 1 shows the symbols used herein to describe various software entities and their interrelationships. As shown in FIG. 1, symbol 100 refers to a container subsystem, symbol 110 refers to a class, symbol 120 refers to a component instance, symbol 130 refers to an object, symbol 140 refers to an interface, symbol 150 refers to an interrelationship of“implements,”, symbol 160 refers to an interrelationship of “uses,” and symbol 170 refers to an interrelationship of “inherits.” FIG. 2 shows various of the interrelationships shown in FIG. 1. As shown in FIG. 2a, the class “child” inherits class “Parent.” As further shown in FIG. 2b, class “Automobile” implements interface “Vehicle.” As still further shown in FIG. 2c, class “Automobile” uses classes “Wheel” and “Seat.” Lastly, as further shown in FIG. 2d, car 27 is an instance of class “Automobile.”

An ECOMB Container fabricated in accordance with the present invention includes the following: (a) a subsystem that gives dynamics to Enterprise CommunicatorBeans; (b) an Enterprise CommunicatorBean interface and utility interfaces that unify communication protocols; (c) classes that support the Enterprise CommunicatorBean interfaces and utility interfaces, and that implement specific secure communication protocols; and (d) an Enterprise CommunicatorBean deployment system.

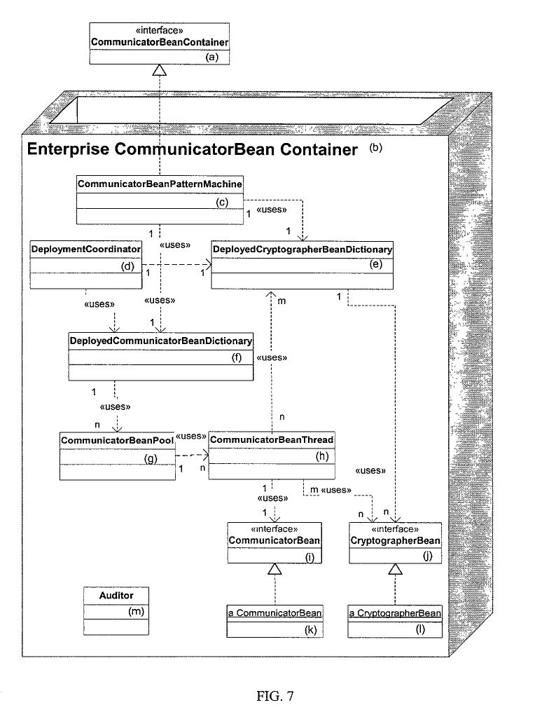

FIG. 7 shows a block diagram of software subsystems (along with their interrelationships) that comprise one embodiment of the present invention. In accordance with this embodiment of the present invention, Enterprise CommunicatorBean Container 7b manages Enterprise CommunicatorBeans and a single interface (CommunicatorBeanContainer interface 7a) through which all communication is requested. As shown in FIG. 7, CommunicatorBeanPatternMachine 7c is the sole implementer of the single CommunicatorBeanContainer interface 7a. Thus, whenever a higher-level subsystem requests communication, it employs this single interface, and requests use or access to an Enterprise CommunicatorBean by way of its assigned name. Further, CommunicatorBeanPatternMachine 7c maintains responsibility to manage the life cycle of Enterprise CommunicatorBeans, and also to guarantee delivery of payloads whenever transmission fails. In accordance with this embodiment of the present invention, CommunicatorBeanPatternMachine 7c guarantees delivery for one or more protocols by seeing that a transmission completes successfully in accordance with methods that are well known to those of ordinary skill in the art. In accordance with one embodiment of the present invention, embodiments of the inventive systems operate by implementing the following: (a) a component manager/component contract; (b) a client/component contract; (c) a deployment contract; and (d) an Administrative User Interface.

As shown in FIG. 7, DeploymentCoordinator 7d drives a deployment system while CommunicatorBeanPatteriMachine 7c drives client runtime. Together, DeploymentCoordinator 7d and CommunicatorBeanPatternMachine 7c initiate processing that may be declared using a deployment descriptor.

In accordance with this embodiment of the present invention, DeploymentCoordinator 7d receives a communication component deployment file utilizing any one of a number of methods that are well known to those of ordinary skill in the art. For example, and without limitation, DeploymentCoordinator 7d can poll a predetermined subdirectory of Enterprise CommunicatorBean Container 7b for the presence of a new deployment file, or DeploymentCoordinator 7d can be invoked directly by way of an Enterprise JavaBean SessionBean that represents DeploymentCoordinator 7d in accordance with methods that are well known to those of ordinary skill in the art. Then, in response, DeploymentCoordinator 7d reads each of the components in the new deployment file, along with their associated deployment descriptors. In accordance with this embodiment of the present invention, the components read by DeploymentCoordinator 7d may either be a class or a serialized component instance. However, whenever the component read is a class, the class is instantiated in accordance with methods that are well known to those of ordinary skill in the art. Nevertheless, in either case, DeploymentCoordinator 7d deploys a component by making an entry in DeployedCommunicatorBeanDictionary 7f. The component's deployment descriptor name is used as a key to CommunicatorBeanPool 7g —but with N copies of the component instance as shown in FIG. 7k where N is the maximum number of threads designated in the deployment descriptor for the component. In accordance with this embodiment of the present invention, cryptographer components are always read as a class rather than an instance. DeploymentCoordinator 7d deploys each cryptographer component by making an entry in DeployedCryptographerBeanDictionary 7e. The component's deployment descriptor name is used as a key to the cryptographer component in this dictionary.

CommunicatorBeanPatternMachine 7c implements processing for all client interface invocations. For example, CommunicatorBeanPatternMachine 7c routes requests to the correct CommunicatorBeanPool based on the name of the component for which a request is intended. CommunicatorBeanPatternMachine 7c also handles adding listeners to a CommunicatorBeanPool (this will be described in detail below). CommunicatorBeanPatternMachine 7c also manages several administrative functions through its CommunicatorBeanContainer interface 7a. For example, using CommunicatorBeanContainer interface 7a, CommunicatorBeanPattermMachine 7c causes the entire Enterprise CommunicatorBean Container 7b to be: (a) started; (b) shutdown; (c) queried for currently deployed communication and cryptographer components; (d) requested to deploy additional component deployment files into the container; and (e) queried for historic occurrences (i.e., to provide an audit trail of various types) in accordance with methods that are well known to those of ordinary skill in the art.

As mentioned above, in accordance with the present invention, a CommunicatorBeanPool is instantiated, and N associated component instances are constructed for each component deployed. However, to do this a CommunicatorBeanThread such as, for example, CommunicatorBeanThread 7h that encapsulates each component is constructed in accordance with methods that are well known to those of ordinary skill in the art. As such, each CommunicatorBeanThread object acts as a “wrapper” for a component. This wrapper is advantageously used so that a CommunicatorBeanPool can interact with each component in a more complex manner than the component was actually constructed to handle by itself. As one can readily appreciate, advantageously, this provides beneficial behavior that does not need to be coded by a component developer. For example, in one embodiment of the present invention, receiver components will have their corresponding CommunicatorBeanThread wrapper control polling on their behalf, for example, by starting polling and stopping it in accordance with methods that are well known to those of ordinary skill in the art.

In accordance with one embodiment of the present invention, each CommunicatorBeanThread interacts with a single communication component, but only by way of one of three communication interfaces (these interfaces will be described in detail below): (a) a TransmitterBean interface; (b) a MultiTransmitterBean interface; and (c) a ReceiverBean interface, where each interface inherits CommunicatorBean interface 7i.

In accordance with this embodiment of the present invention, whenever a client registers as a listener to a communication component protocol, it actually intends to be notified of an event regardless of the specific thread of the component that has something to report. As a result, in accordance with this embodiment of the present invention, listeners are added to an array maintained by the CommunicatorBeanPool object. Further, whenever a communication component employs a CommunicatorContext interface (to be described in detail below) to notify listeners, it is actually invoking a method on its corresponding CommunicatorBeanPool object, which CommunicatorBeanPool object processes a loop through the array of listeners, and notifies each one in turn. Note that this allows a listener to get notification regardless of which thread in a pool invokes notifyListeners( ).

In accordance with this embodiment of the present invention, deployments of CommunicatorBeans that have designated the name of a cryptographer component save this name in its associated CommunicatorBeanThread. In this way, TransmitterBeans whose clients invoke TBObject.syncTransmitNext( ) or TBObject.asyncTransmitNext( ) will actually have the payload encrypted via CryptograhperBean.encrypt( ) by the ConmmunicatorBeanThread object processing by the time TransmitterBean.syncTransmitNext( ) or TransmitterBean.asyncTransmitNext( ) is called. Likewise, the CommunicatorBeanThreads will decrypt a payload transparently with respect to a component developer's code as payloads are received. CommunicatorBeanThreads can only access cryptographer components by way of CryprographerBean interface 7j. Note that in accordance with this embodiment of the present invention, certificate management is to be handled by CryptographerBeans, or their associated subsystems, without the ECOMB container's knowledge. Of course, communication component developers may still code encryption and decryption directly into their communication components, and not use cryptographer components at all. However, cryptographer components provide a method to support encryption in a way that is transparent to communication component developers.

Finally, CommunicatorBeanPatteriMachine 7c, DeploymentCoordinator 7d, CommunicatorBeanPools (for example, CommunicatorBeanPool 7d), and CommunicatorBeanThreads (for example, CommunicatorBeanThread 7h) may all use Auditor class 7m in accordance with methods that are well known to those of ordinary skill in the art to record any salient occurrences in order to maintain an historic audit trail which may be queried any time later in accordance with methods that are well known to those of ordinary skill in the art.

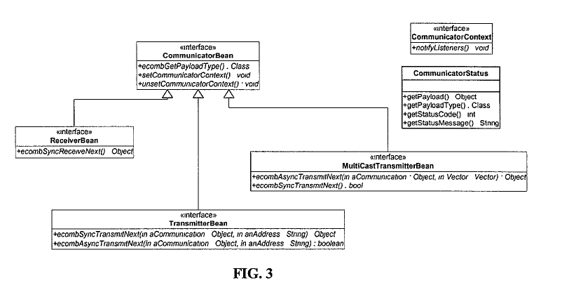

In accordance with the above-described embodiment of the present invention, an Enterprise CommunicatorBean Container is a Communications Manager that embodies a set of interfaces that inherit an interface referred to as CommunicatorBean. As such, communication is achieved by constructing a class that implements one of CommunicatorBean's sub interfaces. Thus, in order to utilize the embodiment of the present invention shown in FIG. 7, a communication component developer must write class code that conforms to one of the three child interfaces pictured in FIG. 3, i.e., a Transmitter interface, a MultiTransmitter interface, or a Receiver interface. The full signatures of the interfaces and utility classes shown in FIG. 3 are listed below.

[image]

[image]

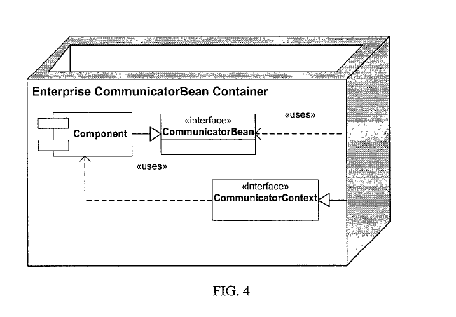

As shown in FIG. 3, and as set forth above, there exists some common methods across each of these three child interfaces, and these common methods are available by way of a parent CommunicatorBean interface. As one of ordinary skill in the art can readily appreciate, a primary feature of the shared CommunicatorBean interface is the setCommunicatorContext( ) method that is invoked by an ECOMB Container in accordance with the present invention at the time a communication component is deployed thereinto. As shown in FIG. 4, it is through this method that the ECOMB Container provides an object that implements the CommunicatorContext interface to each and every deployed communication component. In accordance with one embodiment of the present invention, communication components can save this interface in an instance variable, and use it at any time to signal listeners (this was described in detail above). Advantageously in accordance with embodiments of the present invention, component developers need only write code for synchronous transmission, asynchronous transmission, and synchronous receiving, thereby enabling them to concentrate on developing code focused on accomplishing an intended communication protocol.

Transmitter component developers, for example, need not code for guaranteed delivery. Transmitter components must return “false” when transmission fails. In response, their corresponding CommunicatorBeanThread will retry the transmission several times (in accordance with one embodiment of the invention, this number is a configured quantity) before persisting the payload and destination address in a file and automatically notifying any TransmitterListener for the component. The ComponentBeanPool will then automatically retry the transmission a configured time later, and try several times again if necessary. This process repeats until the transmission succeeds.

Cryptographer components may also be constructed to provide transparent encryption and decryption of payloads. In order to do so, a cryptographer component developer must implement the following interface for each such component:

interface CryptographerBean
{
Object encrypt(Object anUnencryptedObject);
Object decrypt(Object anEncryptedObject);
}

In accordance with one embodiment of the present invention, one Enterprise CommunicatorBean implements a specific communication protocol, which may or may not include an implementation of a security protocol. The following are some Enterprise CommunicatorBeans: (a) FileSystemTransmitter, FileSystemReceiver; (b) HTTPTransmitter, HTTPReceiver; (c) HTTPSTransmitter, HTTPSReceiver; (d) SMTPMIMETransmitter, SMTPMIMEReceiver; (e) SMTPSMIMTransmitter, SMTPSMEMEReceiver; (f) FTPTransmitter, FTPReceiver; and (j) FAXTransmitter, FAXReceiver.

In accordance with one embodiment of the present invention, a payload for each Enterprise CommunicatorBean is a Java Object. The actual class of the Java Object, which Java Object may further define structure and format, must be known by any computer subsystem that uses the Enterprise CommunicatorBean. While Enterprise CommunicatorBeans may be accessed using remote interfaces, typically they are not to be employed across physical machines. This is because, in some embodiments, clients of Enterprise CommunicatorBeans are local, and in the same process, as the Enterprise CommunicatorBean when they are accessed in order to communicate to a target subsystem on another machine.

The following describes Enterprise CommunicatorBean Classes. In accordance with one embodiment of the present invention, there are four classes per protocol, i.e., there is a TransmitterBean class and a ReceiverBean class for both a non-secure and a secure implementation of each communication protocol.

Table 1 shows an implementation framework for each communication protocol to be employed, both secure and non-secure modes of transport are listed. Table 2 lists various states of Enterprise CommunicatorBeans during runtime and describes their activities.

TABLE 1
Software (for example, Java Classes) used to Implement a Protocol

| Protocol | Non-secure | Secure |
|---|---|---|
| File | JDK x.x.x | Cyrptographer component using |
| System | | JDK x.x.x with Java Cryptography |
| | | Extension (JCE 1.2.1) |
| HTTP | JDK x.x.x | Java Secure Socket Extension |
| | | (JSSE 1.0.2) |
| SMTP | JavaMail 1.2 | PKCS7.com has a JavaMail |
| | | extension package to support |
| | | Internet Mail with Secure MIME. |
| | | For details visit |
| | | http://www.pkcs7.com/index.html |
| FTP | FTP Client Bean | JDK x.x.x with Java Secure |
| | There is a company which | Socket Extension (JSSE 1.0.2) or |
| | provides FTP client bean | Cryptographer component using |
| | software with source code. | JDK x.x.x with Java Cryptography |
| | For details visit | Extension (JCE 1.2.1) |
| | http://www.eos.dk:8080/ | |
| | beans/ftp/index.html | |
| FAX | Java Communications | Cryptographer component using |
| | API 2.0 | JDK x.x.x with Java Cryptography |
| | | Extension (JCE 1.2.1) |

TABLE 2
Behavior of Enterprise CommunicatorBeans With
Respect to Their Actual Transport Subsystem

| State | Protocol | Transmit | Receive |
|---|---|---|---|
| Request | HTTP | Client(s) of | Servlet receives |
| discovery | | ECOMB invoke | request and saves |
| | | syncTansmitNext( ) | file to a specific file |
| | | | system directory. |
| | | | ECOMB polls the |
| | | | file folder for any |
| | | | new document. |
| | SMTP/POP3 | Client(s) of | ECOMB |
| | | ECOMB invoke | periodically polls |
| | | syncTansmitNext( ) | POP3 server at |
| | | | specific mail |
| | | | address. |
| | FTP | Client(s) of | ECOMB |
| | | ECOMB invoke | periodically polls |
| | | syncTansmitNext( ) | specific FTP file |
| | | | directory. |
| | File System | Client(s) of | ECOMB |
| | | ECOMB invoke | periodically polls |
| | | syncTansmitNext( ) | specific file system |
| | | | directory. |
| | FAX | Client(s) of | FAX subsystem |
| | | ECOMB invoke | receives FAX |
| | | syncTansmitNext( ) | document and saves |
| | | | file to a specific file |
| | | | system directory. |
| | | | ECOMB polls the |
| | | | file folder for any |
| | | | new document. |
| Request | HTTP | Transmission via | Retrieve file from |
| communication | | web server | specific file system |
| | | | directory after |
| | | | Servlet puts it there. |
| | SMTP/POP3 | Transmission via | Receive file from |
| | | SMTP client | attachment in email |
| | | | at specific email |
| | | | address mailbox in |
| | | | POP3 Server |
| | FTP | Transmission via | Receive file from |
| | | FTP client | specific file |
| | | | directory in FTP |
| | | | server |
| | File System | Transmission via | Retrieve file from |
| | | File System | specific file system |
| | | | directory. |
| | FAX | Transmission via | Retrieve file from |
| | | serial comm. | specific file system |
| | | | directory after FAX |
| | | | subsystem puts it |
| | | | there. |
| Idle | HTTP | Call Object::wait( ) | Call Object::wait( ) |
| | | and sleep | with timeout and |
| | | | periodically poll |
| | FTP | Call Object::wait( ) | Call Object::wait( ) |
| | | and sleep | with timeout and |
| | | | periodically poll |
| | SMTP/POP3 | Call Object::wait( ) | Call Object::wait( ) |
| | | and sleep | with timeout and |
| | | | periodically poll |
| | FTP | Call Object::wait( ) | Call Object::wait( ) |
| | | and sleep | with timeout and |
| | | | periodically poll |
| | File System | Call Object::wait( ) | Call Object::wait( ) |
| | | and sleep | with timeout and |
| | | | periodically poll |
| | FAX | Call Object::wait( ) | Call Object::wait( ) |
| | | and sleep | with timeout and |
| | | | periodically poll |

The following sets forth the FileSystem TransmitterBean and ReceiverBean classes: public class FileSystemTransmitter implements TransmitterBean

[image]

[image]

[image]

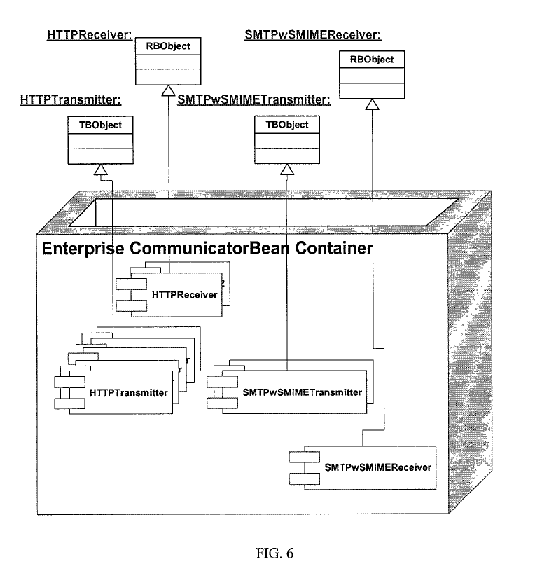

The following describes the deployment of Enterprise CommunicatorBeans. In accordance with one embodiment of the present invention, one or more communication components are packed into a single file, along with a deployment descriptor text file that provides declarative instructions for each component to the container. This file is deployed into the container in the manner described above. For example, as was described above, whenever a communication component is deployed, the container automatically generates an object implementing a client interface and stores it in a directory service located at a name assigned to the communication component in the deployment descriptor (see FIG. 6).

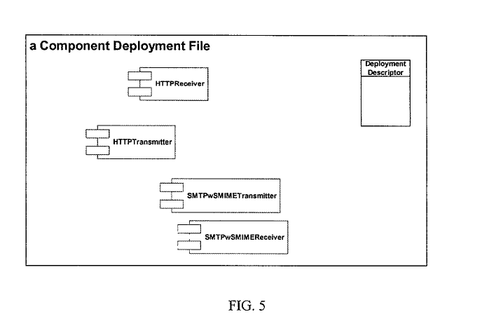

When communication and cryptographer components have been coded, they are ready for deployment. In accordance with one embodiment of the present invention, in order to deploy one or more communication components at the same time, their executable file forms are put into a single file such as a ZIP file or other file format that is able to maintain an internal directory structure and store one or more embedded files. Each communication component may reside anywhere in the internal directory structure, and components may be grouped into the same or multiple deployment files for organizational purposes. An example of a component deployment file is shown in FIG. 5. Also shown in FIG. 5 is a text file known as a deployment descriptor that is located, for example, and without limitation, in an internal directory “META-INF”. The deployment descriptor provides deployment configuration instructions to the container for each communication component. In accordance with a preferred embodiment of the present invention, XML is used to declare such deployment instructions. Specifically, deployment instructions for each component type comprise:

for a transmitter component: a string designating a directory name for the component (for example, its JNDI name); a string designating the internal deployment file path name to a file containing executable code for the component; a string designating an internal deployment file path name to a serialized state of an instance; a string designating a name of a registered cryptographic algorithm; a string designating a name of a component model (for example, Java, Microsoft COM, CORBA, or any other component model); and an integer designating a maximum number of threads that the ECOMB Container will construct for the component.

for a receiver component: all of the above as given for a transmitter component; and an integer designating a number of milliseconds that the ECOMB Container should wait between calling ecombSyncReceiveNext( ) in order to poll on behalf of the receiver component.

for a cryptographer component: a string designating a container internal name for the component; and a string designating an internal deployment file path name to a file containing executable code for the component.

In accordance with one embodiment of the present invention, Enterprise CommunicatorBeans may be stored in Enterprise CommunicatorBean JAR files also referred to herein as “ECOMB JAR” files (the configuration of the Enterprise CommunicatorBeans described by an ECOMB Deployment Descriptor is also included within the ECOMB JAR file). Advantageously, this embodiment enables Enterprise CommunicatorBeans to be saved, and then deployed at any time.

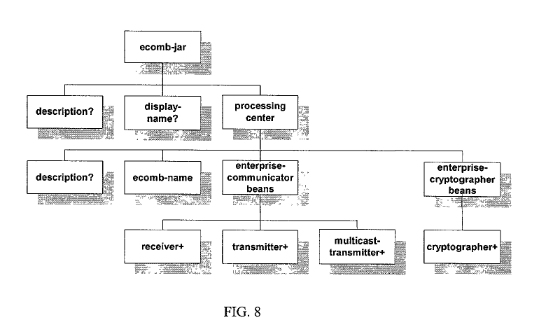

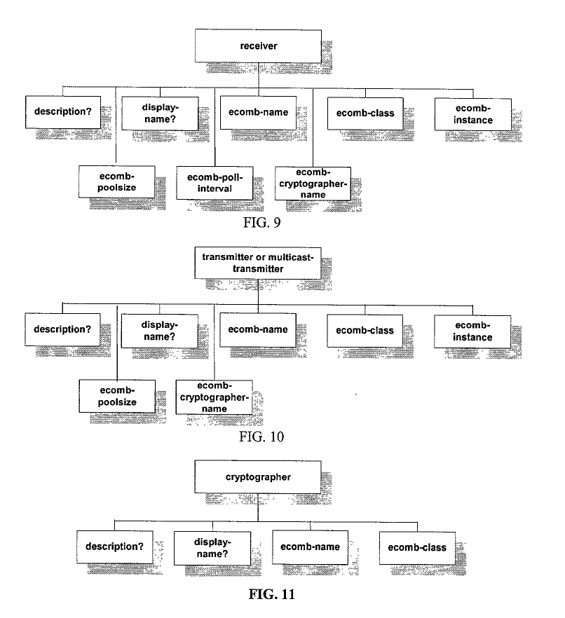

FIG. 8 shows a block diagram of an XML grammar structure of an ECOMB JAR that is fabricated in accordance with the present invention, FIGS. 9 and 10 show block diagrams of an XML grammar structure of receiver beans, and for transmitter or multicast transmitter beans, while FIG. 11 shows a block diagram of an XML grammar structure of cryptographer beans that are fabricated in accordance with the present invention, respectively.

The following describes the client/component contract. In one embodiment of the present invention, clients of Enterprise CommunicatorBeans use the CommunicatorBeanContainer interface, which interface is implemented by the ECOMB Container in the manner described above. In a further embodiment of the present invention, instead of using the CommunicatorBeanContainer interface, clients may utilize remote interfaces for Enterprise CommunicatorBeans that are stored in JNDI. However, even in such a further embodiment, there will still have to be a JNDI entry for the ECOMB Container in order to perform deployment, startup, and shutdown.

FIG. 6 shows components of FIG. 5 that are deployed in an ECOMB Container with a thread multiplicity that was designated in the Deployment Descriptor. Additionally, client interfaces have been automatically generated by the ECOMB Container and deployed in a directory service at the names shown underlined in a manner that is well known to those of ordinary skill in the art. In accordance with one embodiment of the present invention, clients can look up these client interfaces in the directory service in a manner that is well known to those of ordinary skill in the art, and access communication components indirectly using them. The client interfaces maintain the signatures listed below in a manner that is well known to those of ordinary skill in the art.

[image]

[image]

[image]

[image]

While most of the methods on the TBObject, MTBObject, and RBObject interfaces directly correspond to communication component interface constituents, the addTransmitterListener( ) and addReceiverListener( ) methods do not. The implementations of these methods are provided by the ECOMB Container in accordance with any one of a number of methods that are well known to those of ordinary skill in the art. The ECOMB Container stores a list of all listeners added in accordance with any one of a number of methods that are well known to those of ordinary skill in the art, but maintains an association of such listeners with a specific component without the component's being aware of its listeners in accordance with any one of a number of methods that are well known to those of ordinary skill in the art.

However, in accordance with this embodiment of the present invention, communication component developers must still be aware that listeners exist. This is because, any point in time a communication component is performing processing, it can invoke notifyListeners( ) on its previously acquired CommunicatorContext interface (see FIG. 4). This enables the communication component asynchronously to notify any listeners that may be associated with the component. When performing such notification, the component may submit a CommunicatorStatus object. However, the ECOMB Container performs the processing required to notify each listener since only it has the list of listeners.

At runtime, a client of a communication component, such a client may be a client with a user interface or it may be a server process requiring communication, must know the directory name of the communication component it will employ. The client uses the directory service to obtain the client interface, and requests synchronous transmission, asynchronous transmission, or synchronous reception.

An embodiment of the present invention also supports asynchronous reception. To do so, a client must invoke startAsyncReceiver( ), and then add itself as a listener by way of addReceiverListener( ). The startAsyncReceiver( ) invocation is a signal to the container that the ReceiverBean must have its ecombSyncReceiveNext( ) method periodically invoked to achieve an automated “polling” operation. As an asynchronous listener, the client must implement the ReceiverListener interface. Whenever a reception comes in, the listener will be invoked immediately via its ReceiverListener.asyncReceiveStatus( ) method. Whenever a listener receives a CommunicatorStatus object, the methods on this object maybe invoked just to look at status or they may be invoked to obtain an actual payload.

Clients desiring to behave as TransmitterListeners operate similarly, but do not require a call to any start( ) methods to get going. Also, TransmitterListeners typically will only desire to observe status and messages rather than payload.

The following describes ECOMB JAR Resource files. In accordance with one embodiment of the present invention, there are three categories of resource files: (a) category 1 relates to support files (for example, external native programs or configuration files); (b) category 2 relates to JNI native libraries (for example, dll or .so files); and (c) category 3 relates to class and java files.

Category 1 files are stored in a JAR in a directory that corresponds to the bean name. For example, resources for the bean: com.verano.ecomb_bean.satellite.SatelliteReceiverBean should be stored in the JAR at resources/com/verano/ecomb_bean/satellite/SatelliteReceiverBean/. All files and any files in any subdirectories under this location will be extracted to %ECOMB_HOME%/respository/resources/com/verano/ecomb_bean/satellitelSatelliteRec eiverBean/where%ECOMB_HOME%is the directory that the ECOMB Container was installed.

Category 2 files are stored in a similar location. For the bean com.verano.ecomb_bean.satellite.SatelliteReceiverBean native libraries should be stored in the JAR at resources/corn/verano/ecomb_bean/satellite/SatelliteReceiverBean/native. All files in this location are extracted to %ECOMB_HOME%/repository/resources/native/SatelliteReceiverBean/<JAR_DATE>/ where <JAR_DATE> is the date and time the jar was created.

Category 3 files are stored in the JAR normally and according to the JavaBean specification.

The following describes how files are extracted at deployment time. In accordance with one embodiment of the present invention, resource files will be extracted from a JAR at deployment time or at Enterprise CommunicatorBean Container start time. If a resource file already exists, the file will be overwritten if the JAR was created after the last modified date of the file. Thus, if one modifies the file and then starts the Enterprise CommunicatorBean Container, the file will not be overwritten, However, if one deploys a newer version of the JAR, the file will be overwritten. At undeployment time (i.e., whenever the JAR is deleted) the resource files will be deleted. In addition, if the deployment descriptor does not include a bean's information, the bean's support files will not be extracted from the JAR file.

In accordance with one embodiment of the present invention, an Enterprise CommunicatorBean locates its support files at runtime by appending the bean name to a path to the location of a resources directory. For example, in one embodiment of the present invention, a system Java property variable “ecomb.workarea” is set to the location of the resources directory. For example, %ECOMB_HOME%/repository/resources.

Those skilled in the art will recognize that the foregoing description has been presented for the sake of illustration and description only. As such, it is not intended to be exhaustive or to limit the invention to the precise form disclosed. For example, although embodiments of the present invention have been described using component managers which comprise Enterprise CommunicatorBean Containers and using components which comprise Enterprise CommunicatorBeans, those of ordinary skill in the art should readily appreciate that the present invention is not limited to such embodiments. In fact, it is within the spirit of the present invention to include any embodiment of component managers and components.

What is claimed is:

1. A component manager that manages one or more communication components that implement one or more communication protocols, the component manager comprising:
an encapsulator that generates an object implementation of a pre-established interface for each of the one or communication components, wherein each such object implementation of the interface provides indirect access to its associated communication component and directives to the component manager that must be executed on behalf of the associated communication component, which directives are not communicated to the associated communication component;
a directory service object submitter that inserts an object representing a client interface for a communication component into a directory, which object can be retrieved using a name assigned to the communication component;
a synchronous transmitter invoker that executes an identified synchronous transmit method in a communication component that implements a transmitter interface to synchronously transmit a payload; and
a synchronous receiver invoker that executes an identified synchronous receive method in a communication component that implements a receiver interface to synchronously receive a payload.

2. The component manager of claim 1 further comprises:
a thread manager that, when threads for a communication component are busy, transparently starts, executes, and manages additional threads for the communication component.

3. The component manager of claim 1 further comprises:
a guarantor that guarantees that a payload in a transmission is delivered to an intended recipient.

4. The component manager of claim 1 further comprises:
an asynchronous transmitter that executes an identified synchronous transmit method in a communications component that implements a transmitter interface to asynchronously transmit a payload.

5. The component manager of claim 1 further comprises:
an asynchronous receiver that periodically executes an identified asynchronous polling to receive method in a communications component that implements a receiver interface to asynchronously receive a payload.

6. The component manager of claim 1 further comprises:
a client listener that registers a client as a listener with a receiver component thread pool and automatically and asynchronously notifies the client of any incoming payloads immediately regardless of which receiver component thread in the thread pool received the payload.

7. The component manager of claim 6 further comprises:
a register that registers one or more encryption algorithms with the component manager; and
an encrypter that transparently encrypts transmitted payloads using an encryption algorithm invoked by name.

8. The component manager of claim 7 wherein:
the register further registers one or more decryption algorithms with the component manager; and
the component manager further comprises a decrypter that transparently decrypts received encrypted payloads using a decryption algorithms invoked by name.

9. The component manager of claim 1 further comprises:
a poller that transparently, automatically, periodically polls for arrived payload on behalf of receiver components.

10. The component manager of claim 9 wherein the poller further comprises:
an intelligent polling manager that does not allow additional component threads to execute whenever one component thread discovers there are no further arrivals.

11. The component manager of claim 1 further comprises:
a remote observer that remotely observes a communication component pool to determine how many threads are busy or waiting.

12. The component manager of claim 1 further comprises:
a remote controller of a communication component pool that may suspend communication by communication components; may resume communication by communicator components, may or shut down communication components.

13. The component manager of claim 1 further comprises:
an auditor that audits received payloads and transmitted payloads.

14. The component manager of claim 1 further comprises:
a deployer that reads and deploys a file including component classes in the component manager.

15. The component manager of claim 1 further comprises:
a deployer that reads and deploys a file including component instances in the component manager.

16. The component manager of claim 14 wherein the deployer further comprises:
a deployment descriptor interpreter that reads a deployment descriptor included in the file wherein a maximum number of threads per communication component protocol may be declared to the component manager.

17. The component manager of claim 16 wherein the deployment descriptor interpreter further:
declares a polling interval for each distinct receiver component protocol in the deployment descriptor.

18. The component manager of claim 16 wherein the deployment descriptor interpreter further:
declares a name of a registered encryption algorithm technique to employ for each distinct communication component protocol.

19. The component manager of claim 1 further comprises:
a software component to operate on components implemented in one of the following component models: JavaBeans, Microsoft COM, and CORBA.

20. The component manager of claim 1 further comprises:
a graphical user interface that enables a user to observe a current state, to observe an audit trail, and to command and control individual communication component protocol thread pools from a remote client machine.
